(19) United States
(12) Patent Application Publication
(10) Pub. No.: US 2011/0149606 A1
(43) Pub. Date: Jun. 23, 2011

(54) AC-TO-DC CONVERTING CIRCUIT APPLICABLE TO POWER-CHARGING MODULE

(75) Inventors: YEH-HSIANG HO, Chiayi County (TW); Yoshihiro Konishi, Hsinchu City (TW); Yi-Shuo Huang, Hualien County (TW)

(73) Assignee: Industrial Technology Research Institute, Hsinchu (TW)

(21) Appl. No.: 12/732,353

(22) Filed: Mar. 26, 2010

(30) Foreign Application Priority Data
Dec. 22, 2009 (TW) 098144210

(51) Int. Cl. H02M 3/335

(52) U.S. Cl. 363/17

(57) ABSTRACT

The AC power generated by AC utility has been successfully transferred from AC-to-DC by means of an AC-to-DC converting circuit. This disclosure provides an AC-to-DC converting circuit applicable to a power-charging module, and the AC-to-DC converting circuit comprises two parts such as a first stage being a low-frequency AC to high-frequency AC converter comprising an input full-bridge rectifier, a full-bridge inverter and an immittance conversion circuit and a second stage being an AC-to-DC converter comprising a single-phase transformer and a full-bridge rectifier, where the inverter in the first stage is switched at high frequencies so as to reduce the size of the transformer in the second stage. Additionally, the immittance conversion circuit is further characterized in voltage to current conversion so as to simplify the control mechanism of the power-charging module, reduce the number of current measuring elements and the cost thereof.

### 1. TECHNICAL FIELD

The disclosure generally relates to an AC-to-DC converting circuit and, more particularly, to an AC-to-DC converting circuit using an immittance conversion circuit for voltage to current conversion so as to simplify the control mechanism of a power-charging module, reduce the number of current measuring elements and the cost thereof.

### 2. TECHNICAL BACKGROUND

With the increase in oil price and the trend of eco-conscious, people have started to worry about the green house effect due to increasing emission of carbon dioxide. Therefore, the demand of clean and environment-friendly energies grows rapidly. The development of electric vehicles and power-charging modules has become a trend that will make the earth healthier. In order to prevent current leakage from rechargeable batteries during charging, a transformer is required to be added to the power-charging module. The power-charging modules can be categorized into high-frequency isolated power-charging modules and low-frequency isolated power-charging modules. Since the high-frequency transformer is compact in size and weight, it gains larger popularity. The currently available power-charging modules can be single-staged or dual-staged. The single-staged converter is advantageous in its simple configuration and thus low cost, but it results in large output ripple current and is thus not suitable for use as a power-charging module for electric vehicles. The dual-staged converter is more complicated, but it results in lower output ripple current and achieves output current stability. Therefore, in this disclosure, the dual-staged configuration is adapted with high-frequency switching control so as to reduce the size of the transformer and thus the cost of the power-charging module.

The examples of conventional AC-to-DC converting circuits are as shown in FIG. 1 (U.S. Pat. No. 6,046,914), FIG. 2 (U.S. Pat. No. 6,856,119) and FIG. 3. The elements and labels in FIG. 1 and FIG. 2 are not to be repeated and described herein. The transformer based on half-bridge conversion has disadvantages such as large size and heavy weight, as shown in FIG. 1. Moreover, the demand in voltage resistance for the switches T1 and T2 is very high, which leads to lower conversion efficiency and higher manufacturing cost. The circuit configurations in FIG. 2 and FIG. 3 are disadvantageous for large number of active switches and current sensors, resulting in higher manufacturing cost.

In view of the above, this disclosure provides an AC-to-DC converting circuit using an immittance conversion circuit for voltage to current conversion so as to simplify the control mechanism of a power-charging module, reduce the number of current measuring elements and the cost thereof.

### SUMMARY

In view of the above, this disclosure provides an AC-to-DC converting circuit using an immittance conversion circuit for voltage to current conversion so as to simplify the control mechanism of a power-charging module, reduce the number of current measuring elements and the cost thereof.

In one embodiment, this disclosure provides an AC-to-DC converting circuit, comprising: an input filter, capable of filtering out harmonic components of an input AC voltage; an input full-bridge rectifier, capable of rectifying the AC voltage into a DC voltage; an inverter, capable of adjusting the DC voltage into a constant output high-frequency AC voltage; an immittance conversion circuit, capable of converting a voltage signal into a current signal; a high-frequency transformer, comprising a first winding being a primary side winding and a second winding being a secondary side winding, capable of transforming the AC voltage generated by the inverter into an AC voltage with various intensities; and an output full-bridge rectifier, capable of rectifying the AC voltage transformed by the high-frequency transformer into a DC voltage.

### BRIEF DESCRIPTION OF THE DRAWINGS

The embodiment of the disclosure will be readily understood by the accompanying drawings and detailed descriptions, wherein:

FIG. 1 is a conventional AC-to-DC converting circuit disclosed in U.S. Pat. No. 6,046,914;

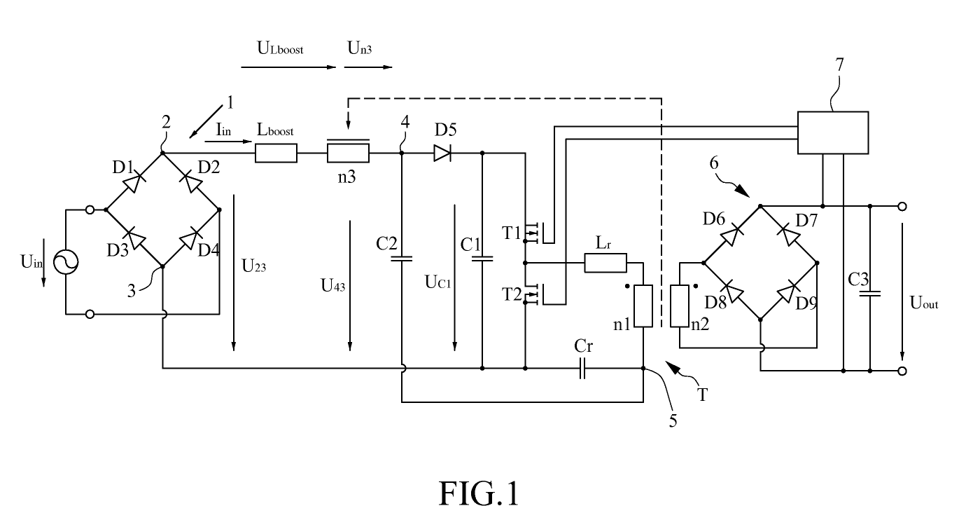

FIG. 2 is a conventional AC-to-DC converting circuit disclosed in U.S. Pat. No. 6,856,119;

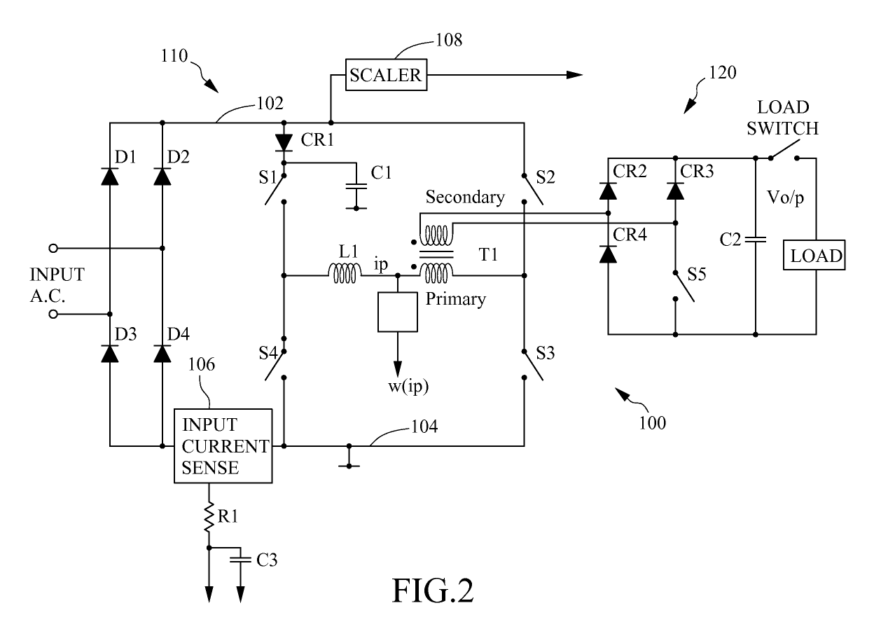

FIG. 3 is another conventional AC-to-DC converting circuit;

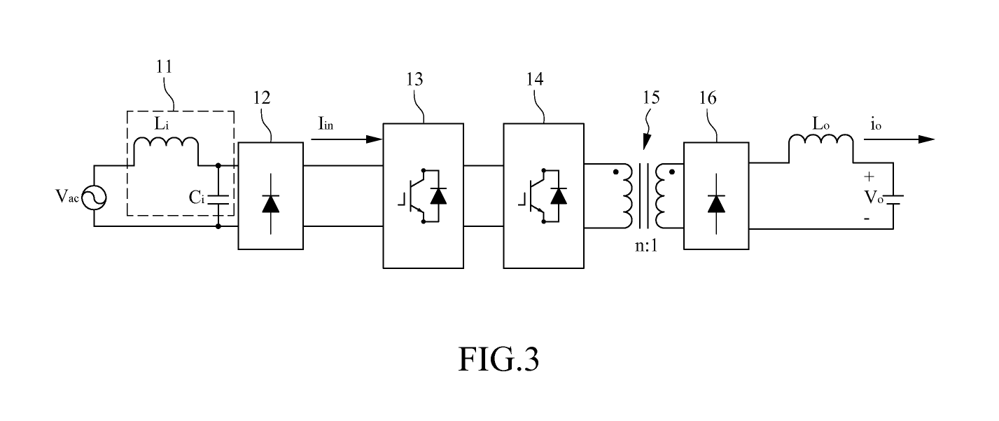

FIG. 4 is a circuit diagram of an AC-to-DC converting circuit in this disclosure; and

FIG. 5 is a detailed circuit layout of FIG. 4.

### DETAILED DESCRIPTION OF THIS DISCLOSURE

The disclosure can be exemplified by but not limited to the embodiment as described hereinafter.

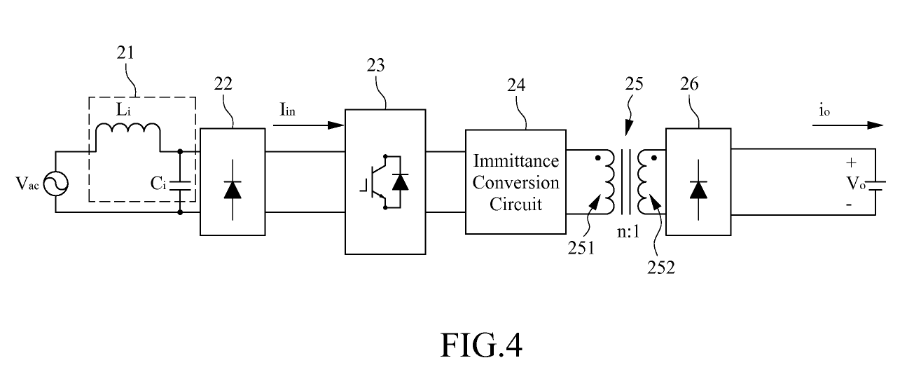

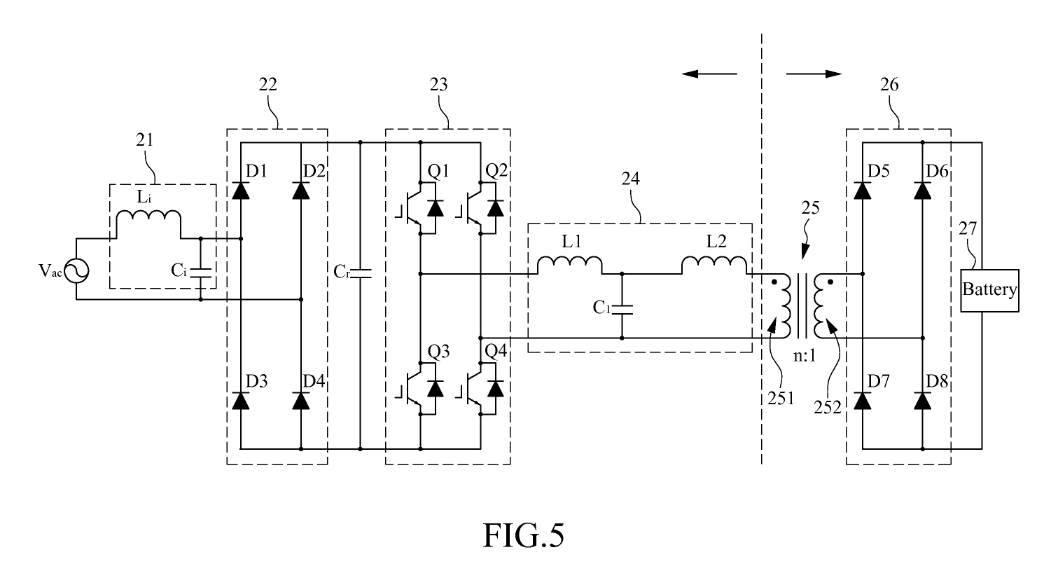

Please refer to FIG. 4, which is a circuit diagram of an AC-to-DC converting circuit in this disclosure. More particularly, FIG. 5 is a detailed circuit layout of FIG. 4, which is suitable for use as a power-charging module for electric vehicles. The AC-to-DC converting circuit applicable to a power-charging module comprises two parts such as a first stage being a low-frequency AC to high-frequency AC converter comprising an input filter 21, an input full-bridge rectifier 22, an inverter 23 and an immittance conversion circuit 24 and a second stage being an AC-to-DC converter comprising a single-phase high-frequency transformer 25 and a full-bridge rectifier 26. These elements are described herein.

The input filter 21 comprises an inductor (Lᵢ) and a capacitor (Cᵢ) and is capable of filtering out harmonic components of an input AC voltage V_{ac}. The output terminal of the inductor Lᵢ is coupled to the positive terminal of the capacitor Cᵢ and further coupled to a node where a diode D1 and a diode D3 joint. The negative terminal of the capacitor Cᵢ is coupled to a node where a diode D2 and a diode D4 joint.

The input full-bridge rectifier 22 comprises four diodes (D1, D2, D3, D4) and is capable of rectifying the AC voltage V_{ac} into a DC voltage. The input full-bridge rectifier 22 is configured by coupling the output terminal of the diode D1 to the output terminal of the diode D2, further to the positive terminal of the capacitor Cᵣ, and further to the input terminals of transistors Q1, Q2, and coupling the output terminal of a transistor Q4 to the output terminal of a transistor Q3, further to the negative terminal of the capacitor Cᵣ, and further to the input terminals of the diodes D4, D3.

The full-bridge inverter 23 comprises four transistors (Q1, Q2, Q3, Q4) and is capable of adjusting the DC voltage into a constant output high-frequency AC voltage by conventional pulse-width modulation (PWM) control or phase-shift control.

The AC-to-DC converting circuit further comprises at least one capacitor Cᵣ for suppressing a surge voltage during switching. The capacitor Cᵣ is optional and is implemented by an external capacitor or the parasitic capacitance of elements.

The high-frequency transformer 25 is an isolation transformer comprising a first winding being a primary side winding and a second winding being a secondary side winding. The high-frequency transformer 25 is capable of transforming the AC voltage generated by the inverter into an AC voltage with various intensities.

The immittance conversion circuit 24 comprises two inductors L1, L2 and a capacitor C₁ and is capable of converting a voltage signal into a current signal. The immittance conversion circuit is configured by coupling the inductor L1 to the inductor L2 in series at a node further coupled to the positive terminal of the capacitor C₁; coupling the input terminal of the inductor L1 to a node where transistors Q1, Q3 joint; coupling a node where transistors Q2, Q4 joint to the negative terminal of the capacitor C₁, further to the output terminal on the primary side 251 of the transformer 25; and coupling the output terminal of the inductor L2 to the input terminal on the primary side 251 of the transformer 25.

The output full-bridge rectifier 26 comprises four diodes (D5, D6, D7, D8) and is capable of rectifying the AC voltage transformed by the high-frequency transformer 25 on the secondary side 252 into a DC voltage. Accordingly, the output full-bridge rectifier 26 is capable of charging a rechargeable battery 27. The input terminal on the secondary side 252 of the transformer 25 is coupled to a node where diodes D5, D7 joint; the output terminal of the diode D5 is coupled to the output terminal of a diode D6 and further to the positive terminal of a rechargeable battery 27; the negative terminal of the rechargeable battery 27 is coupled to the input terminals of diodes D8 and D7; and the output terminal on the secondary side 252 of the transformer 25 is coupled to a node where diodes D6 and D8 joint.

The AC-to-DC converting circuit is applicable to a single-phase or a three-phase power source.

In view of the above, this disclosure provides an AC-to-DC converting circuit using an immittance conversion circuit for voltage to current conversion so as to simplify the control mechanism of a power-charging module, reduce the number of current measuring elements and the cost thereof. The disclosure is therefore novel, non-obvious and useful.

Although this disclosure has been disclosed and illustrated with reference to particular embodiments, the principles involved are susceptible for use in numerous other embodiments that will be apparent to persons skilled in the art. This disclosure is, therefore, to be limited only as indicated by the scope of the appended claims.

What is claimed is:

1. An AC-to-DC converting circuit, comprising:
an input filter, capable of filtering out harmonic components of an input AC voltage;
an input full-bridge rectifier, capable of rectifying the AC voltage into a DC voltage;
an inverter, capable of adjusting the DC voltage into a constant output high-frequency AC voltage;
an immittance conversion circuit, capable of converting a voltage signal into a current signal;
a high-frequency transformer, comprising a first winding being a primary side winding and a second winding being a secondary side winding, capable of transforming the AC voltage generated by the inverter into an AC voltage with various intensities; and
an output full-bridge rectifier, capable of rectifying the AC voltage transformed by the high-frequency transformer into a DC voltage.

2. The AC-to-DC converting circuit as recited in claim 1, wherein the AC-to-DC converting circuit further comprises at least one capacitor Cᵣ for suppressing a surge voltage during switching.

3. The AC-to-DC converting circuit as recited in claim 1, wherein the input filter comprises an inductor Lᵢ and a capacitor Cᵢ.

4. The AC-to-DC converting circuit as recited in claim 3, wherein the output terminal of the inductor Lᵢ is coupled to the positive terminal of the capacitor Cᵢ and further coupled to a node where a diode D1 and a diode D3 joint, and the negative terminal of the capacitor Cᵢ is coupled to a node where a diode D2 and a diode D4 joint.

5. The AC-to-DC converting circuit as recited in claim 1, wherein the input full-bridge rectifier comprises four diodes D1, D2, D3, D4.

6. The AC-to-DC converting circuit as recited in claim 5, wherein the input full-bridge rectifier is configured by coupling the output terminal of the diode D1 to the output terminal of the diode D2, further to the positive terminal of the capacitor Cᵣ, and further to the input terminals of transistors Q1, Q2, and coupling the output terminal of a transistor Q4 to the output terminal of a transistor Q3, further to the negative terminal of the capacitor Cᵣ, and further to the input terminals of the diodes D4, D3.

7. The AC-to-DC converting circuit as recited in claim 1, wherein the inverter comprises four transistors Q1, Q2, Q3, Q4.

8. The AC-to-DC converting circuit as recited in claim 1, wherein the immittance conversion circuit comprises two inductors L1, L2 and a capacitor C₁.

9. The AC-to-DC converting circuit as recited in claim 8, wherein the immittance conversion circuit is configured by coupling the inductor L1 to the inductor L2 in series at a node further coupled to the positive terminal of the capacitor C₁; coupling the input terminal of the inductor L1 to a node where transistors Q1, Q3 joint; coupling a node where transistors Q2, Q4 joint to the negative terminal of the capacitor C₁, further to the output terminal on the primary side of the transformer; and coupling the output terminal of the inductor L2 to the input terminal on the primary side of the transformer.

10. The AC-to-DC converting circuit as recited in claim 1, wherein the output full-bridge rectifier comprises four diodes D5, D6, D7, D8.

11. The AC-to-DC converting circuit as recited in claim 1, wherein the input terminal on the secondary side of the transformer is coupled to a node where diodes D5, D7 joint; the output terminal of the diode D5 is coupled to the output terminal of a diode D6 and further to the positive terminal of a rechargeable battery; the negative terminal of the rechargeable battery is coupled to the input terminals of diodes D8 and D7; and the output terminal on the secondary side of the transformer is coupled to a node where diodes D6 and D8 joint.

12. The AC-to-DC converting circuit as recited in claim 1, wherein the AC-to-DC converting circuit is applicable to a single-phase or a three-phase power source.
